(19) United States
(12) Patent Application Publication
(10) Pub. No.: US 2008/0228784 A1
(43) Pub. Date: Sep. 18, 2008

(54) Double word compare and swap implemented by using triple single word compare and swap

(76) Inventor: James G. Dempsey, Oshkosh, WI (US)

Correspondence Address: James G. Dempsey, 85 Cove Ln, Oshkosh, WI, 54902, US

(21) Appl. No.: 11/716,749

(22) Filed: Mar. 12, 2007

(51) Int. Cl. G06F 17/00

(52) U.S. Cl. 707/100; 707/E17.049

(57) ABSTRACT

A Lock Free and Wait Free method of the appearance of an atomic double word compare and swap (DCAS) operation on a pointer and ABA avoidance sequence number pair of words while using atomic single word compare and swap (CAS) instructions. To perform this function an area of memory is used by this invention and described as a protected pointer. The protected pointer consists of three words, comprising of: a) a pointer to a memory location, such as a node in linked list, together with b) an ABA avoidance sequence number, and combined together with a third word containing c) a specially crafted hash code derived from the pointer and the ABA avoidance sequence number. The three words together are referred to as a three word protected pointer and are used by this invention for implementing a Lock-Free and Wait-Free method of simulating DCAS using three CAS instructions. The specially crafted hash code, when used in a manner as described in this invention, enable competing threads in a multithreaded environment to advance a partially completed method of the appearance of an atomic double word compare and swap (DCAS) operation on a pointer and ABA avoidance sequence number pair of words while using atomic single word compare and swap (CAS) instructions as partially executed by a different thread. The ability for any thread to complete a partially completed appearance of DCAS provides for wait free operation.

### CROSS REFERENCE TO RELATED APPLICATIONS

None

### BACKGROUND OF THE INVENTION

1. Field of the Invention

The coordination amongst execution sequences in a multiprocessor computer.

2. Description of the Related Art

Not Applicable

### SUMMARY OF INVENTION

In computer operating systems and application programs, lists of data items are maintained. Generally these lists are singly-linked lists and/or as doubly-linked lists. In multiprocessor and/or multi-threaded environments the integrity of these lists can be compromised if critical instruction sequences, as performed by one processor, or thread, are interfered with by a similar or same sequence of operations performed by a different processor or thread. Additionally, there exists a well known list maintenance problem known as the ABA problem. See U.S. Pat. No. 6,993,770 Lock free reference counting. Detlefs, et al. Jan. 312, 2006.

The ABA problem occurs where the programming is value dependent on the contents of a pointer and where the programming code is written with the assumption that if the value of the pointer does not change that the values of the data to which it points has not changed. This assumption is not always correct.

A common solution to this problem, as use by those skilled in the art, is to accompany the pointer with a sequence counter as depicted in FIG. 10. The code is adapted such that every time the critical pointer is updated, the counter accompanying the pointer is incremented. When performed in this manner, it is virtually impossible for the computational time taken by one processor or thread through a critical section to be delayed in a manner as to not to notice a change between the pointer-counter pair and thus mistakenly manipulate the data pointed to by this pointer if the data had been modified.

For this paired pointer counter method to work properly in multi-processor and/or multithreaded environments, the pointer-counter pairs must enjoy the privileges of an atomic operation known as double word compare and swap (DCAS). For the purposes of this specification, the pointer-counter pairs reside in adjacent memory locations, as depicted in FIG. 10. And the DCAS operation is described as given the reference of a double word memory structure, a double word comperand and a double word swap value, then provided the contents of memory at the specified address are identical to the double word comperand, perform the swap of the contents of memory at the double word memory reference with the double word swap value and return an indication of whether the compare produced equality (and swap performed), or an indication if the compare produce inequality (and the swap not performed). Some variations of implementation of this instruction return the prior contents of the memory locations pointed to by the double word memory reference in addition to, or in lieu of, the success or failure of the DCAS operation.

Unfortunately, not all computer systems provide a double word compare and swap instruction. Thus requiring the invention of a means to simulate a double word compare and swap using other means such as a sequence of single word compare and swap instructions (CAS) commonly available on said systems. See U.S. Pat. No. 6,223,335 Platform independent double compare and swap operation. Cartwright, Jr. et al. Apr. 24, 2001. Cartwright's patent covers an extension of this method to more than two words to a generalized n-word compare and swap. For the purpose of this specification we will consider only the two word compare and swap simulation.

The invention of this specification provides for a Lock Free and Wait Free method of the appearance of an atomic double word compare and swap (DCAS) operation on a pointer and ABA avoidance sequence number, pair of words while using atomic single word compare and swap (CAS) instructions. To perform this function an area of memory is used by this invention and described as a protected pointer.

The protected pointer consists of three words, as shown in FIG. 11, comprising: a) a pointer to a memory location, such as a node in linked list, together with b) an ABA avoidance sequence number, and combined together with a third word containing c) a specially crafted hash code derived from the pointer and the ABA avoidance sequence number.

The three words together are referred to as a three word protected pointer, as illustrated by FIG. 11, and alternately illustrated as FIG. 12 and FIG. 13, and said three word protected pointer is used by this invention for implementing a Lock-Free and Wait-Free method of simulating DCAS using CAS instructions.

### BRIEF DESCRIPTION OF DRAWINGS

FIG. 1 illustrates the simulated DCAS function to perform the equivalent of a lock free, wait free atomic double word compare and swap operation through the use of three single word compare and swap operations on a three word protected pointer.

FIG. 2 illustrates the SNAPSHOT function used to obtain a consistent copy of a three word protected pointer which is typically used as a comperand in the simulated DCAS function.

FIG. 3 illustrates an example of the HASH function of a pointer and counter, said counter being sequenced in a traditional manner such as n, n+1, n+2, etc. . . . , where counter bits are rearranged in a favorable manner before being combined with the pointer into a reversible combinatorial function such as XOR.

FIG. 3a illustrates an alternate form of an example of the HASH function of a pointer and counter, said counter being sequenced in a non-traditional manner such the advancement of the counter is in a favorable state, thereby permitting the counter to be directly combined with the pointer into a reversible combinatorial function such as XOR.

FIG. 4 illustrates the CONSISTENT function which is used to bring a potentially inconsistent volatile three word protected pointer into consistency and then return a copy of the momentarily consistent pointer.

FIG. 5 illustrates an example use of the functions SANPSHOT, NEXTCOUNT, NEWTCAS, and simulated DCAS in the process of extracting the head node from a single linked list. This illustration does not include the handling of boundary conditions.

FIG. 6 illustrates the NEWTCAS function which produces a consistent three word protected pointer given two input arguments of a pointer and a count or count with flag(s) field.

FIG. 7 illustrates the REARRANGE counter bits function as used in FIG. 3.

FIG. 7a illustrates an alternate REARRANGE counter bits function as used in FIG. 3.

FIG. 8 illustrates the NEXTCOUNT function as an incremental sequencing of the count word while reserving the upper most byte of the count word for use as flags or other purposes.

FIG. 8a illustrates the NEXTCOUNT function as an incremental sequencing of the count word while reserving the upper most bit of the count word for use as flags or other purposes.

FIG. 8b illustrates the NEXTCOUNT function as a non-traditional sequencing of the count word based on the heuristics of the bits in flux of the pointer word and for use in FIG. 3a to produce the hash code.

FIG. 8c illustrates the NEXTCOUNT function as a simple increment of the count word.

FIG. 9 illustrates the BSWAP function which reverses the byte order of an eight byte word.

FIG. 10 illustrates a two word protected pointer.

FIG. 11 illustrates a three word protected pointer.

FIG. 12 illustrates a three word protected pointer where the upper bit or bits of the count word are used, or reserved. An example of which is the inclusion of a flag bit to indicate hardware support for DCAS.

FIG. 13 illustrates a three word protected pointer where the upper bit or bits of the count word are used, or reserved, plus the inclusion of an additional word, use in producing a heuristic counting sequencing as depicted in FIG. 8b.

FIG. 14 illustrates a GROUP0S1S function to return the normalized bits of a pointer that must be always 0's or always 1's for a group size of 8 bits and by use of the BSWAP function.

FIG. 14a illustrates a GROUP0S1S function to return the normalized bits of a pointer that must be always 0's or always 1's for a group size of 8 bits and by use of the ROL function.

FIG. 14b illustrates a GROUP0S1S function to return the normalized bits of a pointer that must be always 0's or always 1's for a group size of 1 bit and by use of the ROL function.

FIG. 15 illustrates a BITREVERSE function to return the bit order reversal of a bit field of a word.

### DETAILED DESCRIPTION

In order to appreciate the functionality of this invention it is best to compare the functionality of this invention with prior art. A good example of prior art is Cartwright's method of using CAS operations to simulate DCAS (See U.S. Pat. No. 6,223,335, Cartwright, Jr. et al., Apr. 24, 2001).

The simulation of DCAS by way of Cartwright's method is general purpose as it imposes little on the requirements of what can be held in the double word memory locations. Cartwright does impose the restriction that the first word be of a predetermined kind, such as a pointer, that excludes certain values and that at least one of these non-kind values can be used to indicate that the double word is busy. In Cartwright's method, when the first word of the double word is marked as busy then any competing threads for this protected pointer must avoid attempts to modify the double word until the double word is no longer marked as busy. Cartwright's method can be called a two word protected pointer, as depicted by FIG. 10.

As viewed by this inventor, and resolved by this invention, Cartwright's method carries excessive computational overhead during attempted concurrent updates of a two word protected pointer.

The Cartwright method uses a busy indicator, which in effect is a lock flag for the double word (two word protected pointer), as depicted in FIG. 10. Thus in a multiprocessor and/or multithreaded system, should the processor or thread owning the double word (the tread that set the busy flag) be context switched out prior to resetting the busy (overwriting with new pointer) then all other processors and/or threads competing for this double word resource would be blocked (by programming consent) from accessing this double word resource for the duration of suspension of the owning thread. The Cartwright method is a locking method, which does not exhibit Lock-Free programming characteristics.

In computational systems that are multithreaded, the cooperation and coordination of the processing is maintained through shared data structures. These data structures are often linked lists, either singly or doubly or perhaps more links. Typically, these lists have two or more critical pointers to the list such as a Head pointer and Tail pointer and potentially other pointers as well. The integrity of the list is insured only by proper manipulation of these pointers.

One of the techniques that aid in maintaining the integrity of these structures is by use of a special memory storage operation, generally implemented in hardware, which performs an atomic compare and swap operation (CAS). The abstraction of this function is CAS(t, c, s) where t is the reference of a memory location that is subject to transition by competing threads, c is a word to compare against the contents of the memory location at the reference of t, and s is the value to swap with the contents of the memory location at the reference of t provided that the contents of the memory location at the reference of t is equal to the value of the comperand c. Some implementations of CAS return a success/fail indication whereas other implementations return the contents of the memory location at the reference of t prior to the compare with c and conditional swap with s.

It has been shown, and accepted by those skilled in the art, that the CAS operation on a pointer alone is insufficient to assure the integrity of the shared data structures.

A well known problem to those familiar with the art is the ABA problem, where if a code sequence observes a pointer to node A of the list, obtains information regarding the state of the list, then is suspended or delayed for sufficient time for the state of the list to transition to state with the pointer under observation to point to node B, then return to third state where the pointer under observation returns back to node A, then upon resumption of the original code sequence of the suspended thread, the mere condition of an equal valued pointer between observation and CAS operation is insufficient to detect list state change, and thus avoid, alteration of the shared data structure with alterations under the false assumption that the state of the list had not changed since the original observation of the shared pointer appeared not to have changed.

The commonly accepted technique, by those familiar with the art, to protect against the ABA problem, is to accompany the location holding a critical pointer with a sequence number. Then, whenever the location holding the critical pointer is updated, even to same value, that the sequence number is incremented and updated as well.

The pair of words are generally held in adjacent memory locations and commonly called by those familiar with the art as a double word, and depicted as in FIG. 10. The double word is functionally referenced together with an operation similar to CAS but which is called a double word compare and swap (DCAS). An abstraction of this function is DCAS(t, c, s). Where t specifies the reference of a protected pointer that is subject to transitions, c specifies the reference of a protected pointer that is to be used as a comperand, and s specifies the reference of a protected pointer that is to be used as a swap value. Various implementations of DCAS may use values, pointers, and/or address of operators to the same effect. The DCAS operation is performed as an atomic operation on the double word protected pointer (pointer, counter).

Unfortunately, not all processors support the DCAS operation in hardware. A software solution to perform the functional equivalent of an atomic DCAS operation is required for the proper maintenance of shared data structures. U.S. Pat. No. 6,223,335 Cartwright, Jr., et al. Apr. 24, 2001 is an example of one such solution.

As used in this specification, the term protected pointer, is context dependent and will refer to one of a) the pointer and ABA avoidance sequence number as used by hardware implemented DCAS depicted, FIG. 10, b) the pointer and ABA avoidance sequence number as used by the Cartwright method depicted, FIG. 10, and c) the pointer, ABA avoidance sequence number plus hash code as used by this invention depicted as FIG. 11, or alternately depicted as FIG. 12 where the Count word contains one or more flag bits, or alternately depicted as FIG. 13 with the inclusion of additional information used to produce the specially crafted hash code.

As used in all three techniques of DCAS, the ABA avoidance sequence number is sequenced upon writing of the protected pointer. Typically the ABA avoidance sequence number is incremented but the ABA avoidance sequence number may be sequenced in other ways (decremented, Grey Code increment, etc. . . . ). The functional requirement of the ABA avoidance sequence number is such that for the worst case term of suspension of a thread between observation of a protected pointer and attempt at DCAS on that protected pointer, that no two sequence numbers will be repeated. This ensures that upon resumption of the suspension of the thread, that this thread will not observe the same pointer/sequence number pair if the pointer/ABA avoidance sequence number has been updated since the observation.

Typically, the duration requirement of protection is very small, a few instruction times on a processor. The short duration might last a few nanoseconds to a few microseconds. However, the operating system is performing other tasks. A processor interrupt can cause a suspension of a thread for a significant amount of time. The longer term suspensions are on the order of a few milliseconds. In some cases several seconds may elapse before the thread resumes. However, it should be noted that the longer term suspensions are usually caused on virtual memory systems by a page fault. An example of which is a dequeue operation on a singly linked list whilst attempting to examine the link pointer in the node of the list that is referenced by the Head of list protected pointer. In this situation, it is possible for the page in which the node at the head of the list resides to be in external storage, and thus as prerequisite for access, must be read in from external storage such as a disk. However, under this circumstance, it must be noted that any competing thread attempting to perform a dequeue operation on the same node will also suspend whilst attempting to read the link pointer of the same node. Subsequently, suspension of threads, such as those of, or similar to, page fault, inhibits sequence advancement of the ABA avoidance sequence number for the duration of the suspension. Any circumstance that would cause a delay longer than a page fault generally will also affect the other threads competing for this pointer/ABA avoidance sequence number. That is to say: the modification of the protected pointer, and thus the advancement of ABA avoidance sequence number will not occur as frequently, or at all, under these extenuating circumstances.

The aforementioned suspension duration characteristics hold true under generally accepted programming practices. Specific, and unrealistic, attacks can be contrived to defeat the protection of the ABA avoidance sequence number. An example of which would be a billion threads on two processor system. Notwithstanding the inability of an operating system to provide the resources to execute an absurdly large number of threads, nor the computational time it would take to observe the counter roll-over. An additional requirement for a role-over of the ABA sequence number would be the accumulated processing time required to perform the useful work on the data contained within the nodes after node extraction.

The Cartwright technique is implemented using CAS instructions in conjunction with the manipulation of the pointer word of the pointer/ABA avoidance sequence number that the pointer word can be recognized as being busy. When the Cartwright simulated DCAS function, as executed by one thread, observes the pointer of pointer/ABA avoidance sequence number as being busy, then the simulated DCAS function by the thread observing the busy condition returns failure. Subsequent simulated DCAS attempts return failure until the pointer is no longer indicating busy. And then the Cartwright DCAS simulation code is permitted to compete for the protected pointer amongst potentially other threads competing for the protected pointer.

The problem with the Cartwright technique is if the thread owning the busy is in a long suspension state, then all intervening simulated DCAS operations by other threads fail and thus all additional threads attempting the simulated DCAS are also blocked from progression. This condition causes unnecessary delay in the executions of the other threads competing for the particular pointer/ABA avoidance sequence number.

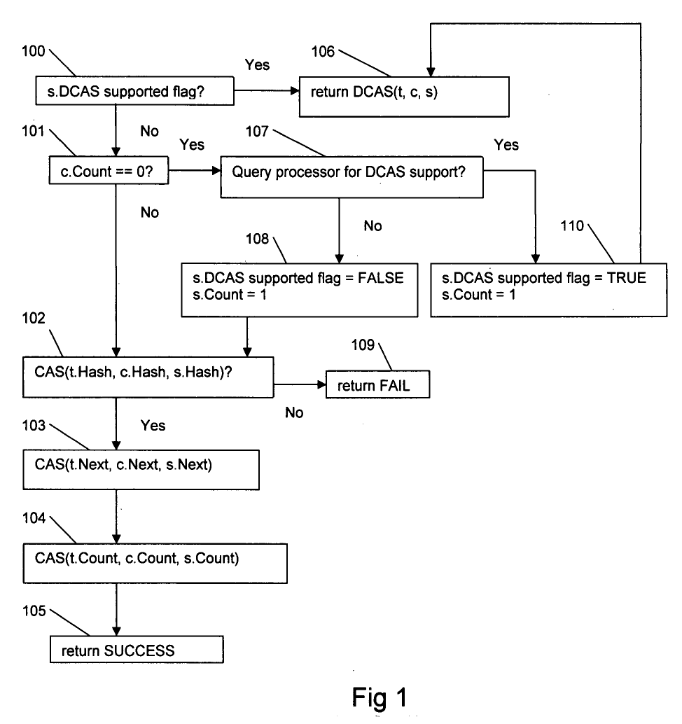

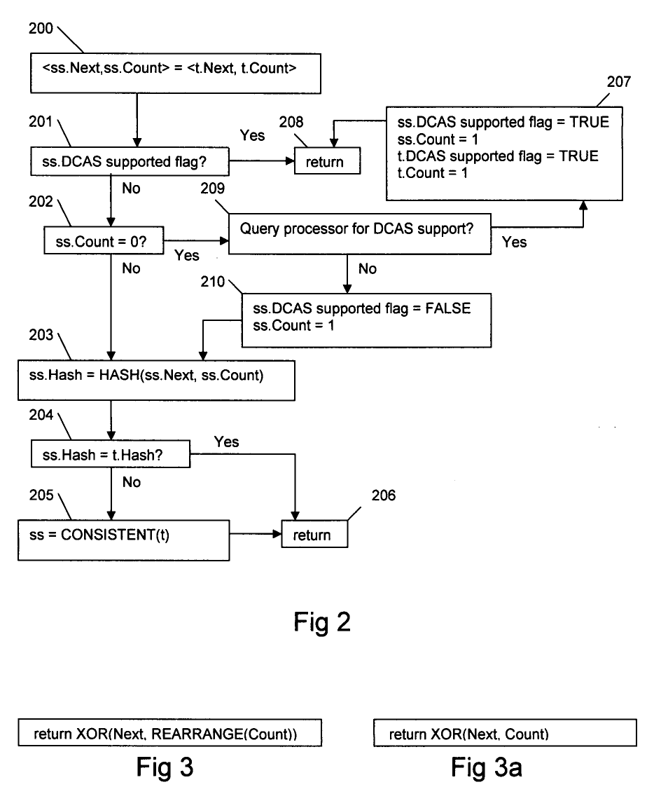

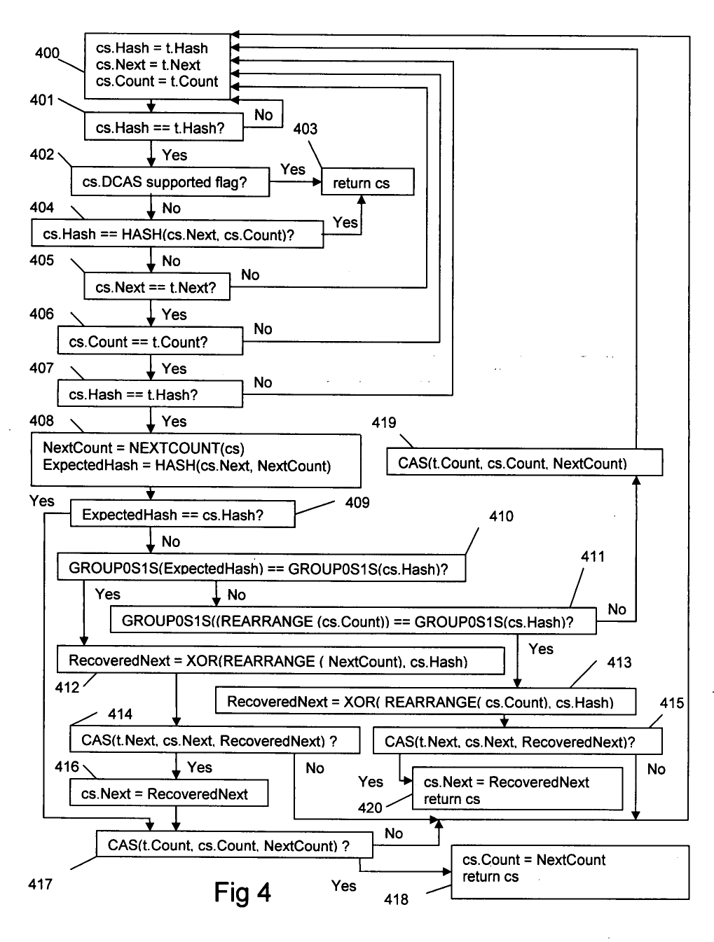

This invention, as specified herein, avoids the unnecessary blocking of competing threads for a given pointer/ABA avoidance sequence number, by means a technique that provides for the elimination of the busy state, and for competing threads to complete a simulated DCAS operation for a suspended thread which was suspended in the process of performing a simulated DCAS. The simulated DCAS portion of this invention is depicted in FIG. 1. And the snapshot and suspended thread state advancement portion of this invention is depicted in FIG. 2 and FIG. 4.

This method of coding is called Lock Free when at least one other thread can advance the state of an otherwise blocking condition. And this method of coding is called Wait Free if all competing threads can advance the state of an otherwise blocking condition. This invention, as specified herein, provides for Wait Free coding of a simulated DCAS operation on a pointer/ABA avoidance sequence number by means of the use of three CAS instructions performed on a three word protected pointer as depicted by the method in FIG. 1.

To accomplish Wait Free operation, a third word is introduced into the two word protected pointer as shown in FIG. 11, or alternately shown in FIG. 12, or alternately in FIG. 13. This third word is a specially crafted hash code word derived from the pointer and ABA avoidance sequence number.

The hash word design will be dependent on several factors. To wit: the instruction set available on the processors on which the code executes, the number of bits in a processor design word, the expected bits in the pointer that vary with valid pointers as used in the data structures on the given processor. Observe that the processor word size may have more bits than the number of bits supported by the addressing capabilities of the system.

Depending on the architecture of the processor, the hash code will be derived from the pointer and ABA avoidance sequence counter with optional, but generally used, rearrangement of the bit positions of the pointer and/or ABA avoidance sequence counter, and a reversible combinatorial operation such as exclusive or (XOR) as depicted in FIG. 3 or alternately depicted in FIG. 3a.

The abstraction of the hash function is HASH(Next, Count) where Next is a pointer to a memory location such as a node in a list, and Count is the ABA avoidance sequence number. The return value of the HASH function is the well crafted hash code.

The primary purpose of the hash code is to express in one word, a value that is sufficiently strong enough to provide ABA avoidance protection for the former two word protected pointer.

A well designed hash function is designed around the knowledge that the pointer argument is not entirely random and together with the knowledge that the ABA avoidance sequence number has a known sequencing order. While a commonly used hashing function, such as Cyclical Redundancy Check (CRC) could be used it, would not be as beneficial as a hashing function constructed with the aforementioned knowledge about the behavioral characteristics of the pointer and ABA avoidance sequence number.

A pointer on a typical computer system points to an area of memory that is generally word aligned, and for a given implementation may be required to be word aligned, or required to be double word aligned. It is not unusual for heap allocation routines to return aligned nodes. For word aligned pointers on a 32-bit word implementation, the least significant two bits of the address will be 0, for a 64-bit word implementation, the least significant three bits will be zero. For other number of bits word sizes a known set of bits in the pointer word of a valid pointer will be known to be zero. For systems were nodes are allocated on double word address, or larger, boundaries an additional bit is, or bits are, available.

Additionally, the most significant bit or bits of the pointer word would exist as a group such that all bits of the group would be all 0's or all 1's but not a mixture of both.

On a 32-bit word system, often one bit can be used to distinguish between system address space and application address space. Or alternately, depending on the implementation, the sign bit might indicate negative addressing for stack addressing. For any given implementation a known number (one or more) of least significant bits of the word aligned pointer will be 0's and a known number (zero or more) of most significant bits of the pointer will be either all 0's or all 1's. For larger word sized systems, and depending on the hardware that implements the virtual addressing system, or the conventions of the operating system, several of the most significant bits of the pointer may be required to be all 0's or all 1's.

As an example, a 64-bit word system (hardware and operating system software) will generally have less than, and use less than, 64-bits of physical addressing and provide for less than 64 bits of virtual addressing. At the time of this application various 64-bit implementations use 32-bits, 44-bits, 48-bits and 56 bits of virtual addressing. The high order bits not available for addressing are required to be all 0's or all 1's.

There are exceptional circumstances where it may be convenient to place an invalid pointer into the protected pointer. An example of which is you may wish to lock a list or node for a longer duration than that of a simulated DCAS operation. The hash code generator and the use of invalid pointers must be designed to work harmoniously. The software design might be such that the least significant bit of a valid pointer, when set, is used to indicate the pointer is invalid yet at the same time hold what used to represent a valid pointer. This contrivance can be described as a locked pointer.

An alternative to using a flag bit in one of the least significant bits position is to use a conceptually valid pointer to a known reserved area. For example on a paged virtual memory system where the first page of virtual memory is reserved, locations within this reserved page could be used as an otherwise valid but reserved pointer. Often page 0 is reserved as a means to identify errant program code. Therefore valid looking pointers pointing within this reserved page could be used (0, 4, 8, etc. . . . ). Alternatively, on larger word sized systems, one of the upper bits in the not available for addressing group of bits which are always 0's or always 1's could be used as a flag.

If the technique of using the least significant bit as a flag bit is used on a 32-bit word system, then this results in at least one bit known to be 0, while the flag bit will occasionally be non-zero. The hash code and the simulated DCAS implementation on 32-bit word systems must take this into consideration. On larger bit word systems with more known (predictable) bit states the hash method has more flexibility.

By maintaining at least one bit known to always be 0, then the hash code generator together with the ABA avoidance sequence number next in sequence generator can be use to generate hash codes that safely identify and manipulate three word protected pointers when the three word protected pointer is partially written by the simulated DCAS operation.

Further characteristics of the pointer are the nodes maintained in a list will generally be allocated as a pool of potential nodes prior to use. There may be one or more such pools of nodes allocated. Pre-allocation of often used nodes is a customary practice as it reduces latencies caused by memory allocation of nodes at the time of need.

Therefore, expected pointers manipulated by the hash function for a given resource (e.g. FIFO queue) will be a subset of all valid address in the address space. For a pool of nodes allocated at one moment in time, all the nodes of the pool tend to be in nearby or adjacent memory locations.

Because of the close proximity of nodes, three zones of bits in the pointer, as use by a given control structure (such as FIFO), tend to remain static. The least significant word alignment bits are always 0, the most significant bits that are not available for addressing are all 0's or all 1's, and a number of bits from the not available for addressing bits down to the zone of bits that fluxate with the subset of available pointers used by the resource. There will be a fourth zone of static bits that exist above the word alignment bits when the nodes as used by the list have larger than word sized alignment characteristics.

Depending on the placement, number of potential nodes, and node alignment restrictions, the number of bits in flux in the pointer may be relatively small as compared to the number of bits available to the pointer. The worst case scenario on 32-bit systems two bits are known to remain static. However, under typical usage, on the order of 16 bits are expected to remain static. And more bits will be observed to be static if the pool of nodes is relatively small. On a 64-bit system the worst case scenario would result in eleven bits being static (upper 8-bits and lower three bits) and under normal usage on the order of 35 bits or more would remain static. And more bits will be observed to be static if the pool of nodes is relatively small.

Using the knowledge about the expected flux pattern in the pointer, together with the known sequencing of the ABA avoidance sequence number, the desire to use a simple reversible computer instruction such as XOR, and the knowledge that XOR is subject to interference problems when two bits in the same bit position of the two arguments to the XOR change in unison, it then becomes desirable that the bits with most flux in the sequence number not be congruent with bits in flux in the pointer. When the bits of the two arguments to the XOR are arranged in an opposite from flux probability order, the XOR will not be subject to large degree of “XOR two bits in same bit position changing in unison interference problem”, and consequently, the hash code is strengthened against ABA avoidance sequence number roll-over.

There are several ways to avoid congruence of the bits in flux between the pointer and the ABA avoidance sequence number. Two of which are to advance the sequence number in a manner that avoids this congruence as depicted in FIG. 8b, or increment (or decrement, Grey Code increment/decrement, etc.) the sequence number as depicted in FIG. 8, FIG. 8a, or FIG. 8c then rearrange the bits in a favorable order to avoid congruence as depicted in FIG. 7 and FIG. 7a.

The particular technique that is most effective for a given processor architecture will be dependent on the instructions available on the processor, number of bits in a word, and the expected bits in flux. Different permutations of rearranging these bits are equivalent to coloring.

A strong hash code could be derived by incrementing the ABA avoidance sequence counter then produce a value for XOR with the pointer, by reversing the bit order of the counter then rotating the reversed bits of the counter to juxtapose against the bits with most flux in the reversed counter against the known zero bits of the word aligned pointer, as depicted in FIG. 7a, and the resultant number used for the XOR with the pointer to produce the hash code.

Arguably, the strongest hash, as depicted in FIG. 8b, could be a hash derived by heuristic observations of the pointers passing through the simulated DCAS operations. Observations such as which bits are always 0, which bits are always 1, and which bits of the upper address bits group in always 0's or always 1's. The remaining bits in the word being determined as belonging to the set of bits in the pointer which experience flux. The bits in flux in a protected pointer can be maintained in the protected pointer as depicted in FIG. 13. Additional words may be added to and stored into the protected pointer as required by the specific hash function.

The heuristically derived hash would then first position the bits of highest flux in the ABS avoidance sequence number against the bits of no flux in the heuristic observation of the pointers, then the next order bits of the ABS avoidance sequence number against the bits of the address that are observed to have the least flux, lastly the remaining bits of the ABS avoidance sequence number against the remaining bits of the address. Depending on the complexity of the code you place in the heuristics, the heuristics code can also determine patterns of multiple pools of nodes. Heuristically derive hash would come at the expense of additional computational overhead.

Most of the current processors do not have instructions that can perform bit reversal translation in one or a few instructions. Therefore a compromise has to be made between the need to produce a strong hash and the need to perform the hash in a small number of steps yet produce a sufficiently strong enough hash to protect against improper manipulation of a protected pointer.

The preferred method, as used by this invention, is to use a combination of rotate bits in the increment of the counter, FIG. 8, and reverse byte order on the count, FIG. 7, in the HASH function depicted in FIG. 3.

All current processors that are candidates of this invention have word size bit rotate and word size byte order reversal instructions. If a bit reversal instruction is available then that would be available to incorporate into the hash function as well.

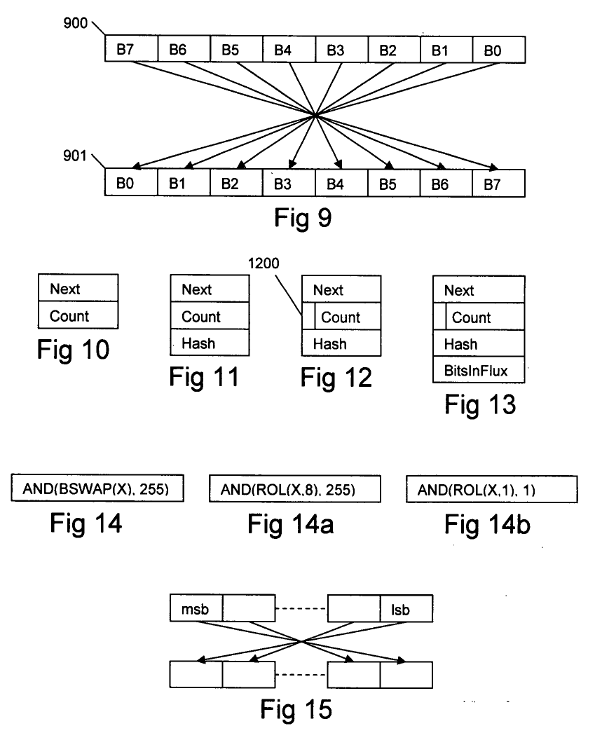

As tested on 64-bit word systems, it was observed that a sufficiently strong enough hash can be produced with a bit truncated incremented counter, FIG. 8, together with reversal of byte order as summarized in FIG. 7 and illustrated in FIG. 9. This would place the least significant eight bits of the ABA avoidance sequence number against the always 0's or always 1's byte of the valid pointer. And the next least significant bits of the ABA avoidance sequence number against the next most significant bits of the pointer (expected not to be in flux), etc. This does not preclude the need for some implementations to require the use of the strongest heuristic hash method as shown in FIG. 8b.

The three word protected pointer (pointer, ABA avoidance sequence number, hash) is considered consistent when the stored hash is equal to a newly computed hash using the stored pointer and the stored ABA avoidance sequence number as illustrated by 404 in FIG. 4.

The construction of the hash code is such that it is commutative. Given values from a consistent protected pointer, the hash can be derived from the pointer and counter, the pointer can be derived from the hash and counter, and the counter can be derived from the hash and pointer. Should a derived hash not equal the stored hash then the protected pointer is not consistent.

Therefore, because the ABA avoidance sequence counter advances in known sequence (such as n, n+1, n+2, . . . ), and because the bits of flux in the repositioned bits of the counter are not congruent with the bits of flux in the pointer, changes in the counter can be observed and identified in the hash word of the three word protected pointer when the three word protected pointer is inconsistent. Of particular interest, as it pertains to this invention, is the ability to determine a) if the current stored counter is in phase (same) as the counter used to produce the hash, b) if the current hash was produced with the hash code generator using a counter that is one count in sequence in advance of the counter stored, and c) by inference, if the counter stored is different than the one used to generate the hash as well as different from the next in sequence counter.

Inconsistent three word protected pointers are caused under two circumstances: a) by the observation of a three word protected pointer between the time of a granting CAS on the hash word of the protected pointer during the simulated DCAS, 102 FIG. 1, and the completion of the CAS on the ABA protected sequence number, Count, of the three word protected pointer during same said simulated DCAS, 104 FIG. 1, or b) a pointer repair operation being suspended immediately prior to the CAS on the pointer, with the intention of correcting the pointer and during said suspension the state changing one or more times where the pointer is returned to the value of that being repaired (otherwise known as an ABA situation). Situation b) will be addressed in more detail in a later paragraph.

Because of characteristic nature of the three word protected pointer, and rules for usage as specified by this invention, as depicted by FIG. 1, it is possible for an inconsistent three word protected pointer to be repaired by the thread observing the inconsistent three word protected pointer as depicted by FIG. 4. As provided by this invention, the ability to repair an inconsistent three word protected pointer enables a Wait Free simulation of the DCAS function using CAS functions.

This invention, as specified by herein, specifies the simulated DCAS function to be accompanied by a snapshot function that is capable of producing a consistent copy of a three word protected pointer, as depicted by FIG. 2, while, and if necessary, simultaneously making the three word protected pointer consistent, as depicted by FIG. 4. This is to say, when the three word protected pointer referenced by the snapshot function is observed as inconsistent, then the snapshot function will advance the state of the inconsistent pointer into the state of being consistent, then return a copy of said consistent three word protected pointer.

An abstraction of the snapshot function is SNAPSHOT(ss, t) where t is the reference of a volatile three word protected pointer, and ss is the reference of a non-volatile buffer that is to receive a consistent copy of a three word protected pointer t. The SNAPSHOT function, FIG. 2, when necessary, 205 FIG. 2, will advance the protected pointer t into consistency using the CONSISTENT function, FIG. 4.

Caution, due to the repair capability of the SNAPSHOT function there exists a non-zero probability that a suspension of the SNAPSHOT at an inopportune time might result, upon resumption, in the inadvertent modification of the pointer word of the three word protected pointer. This inadvertent modification is fleeting in that it is momentarily invalid and momentarily corrected by the current SNAPSHOT or near simultaneous SNAPSHOT performed by a different thread. Due to the potential of a fleeting invalid pointer you are strongly advised to use only the pointer as derived from a SNAPSHOT of a three word protected pointer instead of the pointer word within a volatile three word protected pointer directly.

The NEXTCOUNT function, as specified in this invention, is used to produce the next in sequence ABA avoidance sequence number, given the reference of a three word protected pointer (or copy there of). A function is used in lieu of a simple Count+1, as depicted by FIG. 8c, because the implementation may not necessarily desire to use a sequence of n, n+1, n+2, etc. . . . An advancing Grey Code could be used or the count might advance as n, n+2, n+4, etc. . . . The increment by 2 could provide of the least significant bit of the pointer to be used as a flag bit in a locked pointer scheme. It is up to the design requirements of the programmer implementing this invention to determine how best to sequence the ABA avoidance sequence numbers. FIG. 8, FIG. 8a, FIG. 8b, and FIG. 8c illustrate several of the favorable methods of producing the next in sequence ABA avoidance sequence number, and which said ABA avoidance sequence number is referred to in this specification and figures as Count.

An abstraction of the next ABA avoidance sequence function is NEXTCOUNT(cs) where cs is a reference to a consistent snapshot of a three word protected pointer containing the Count of the current ABA avoidance sequence number, and the return value is the next in sequence ABA avoidance sequence number.

The NEWTCAS function, which is illustrated in FIG. 6, as specified by this invention is: Given the reference of a non-volatile buffer, s in 600, 601, 602 in FIG. 6, an arbitrary pointer, NextNode in 600, 602 FIG. 6 and an arbitrary ABA avoidance sequence number, NextCount in 601, 602 FIG. 6, used together with the hash function, HASH 602 FIG. 6, create a consistent three word protected pointer in the buffer referenced, s in FIG. 6. An abstraction of this function is NEWTCAS(s, NextNode, NextCount).

Architectural designs of processors may, or typically, contain features such as cache memory and/or perform out of order reads, out of order writes, write combining and/or additional features designed to enhance the performance non-ordered sensitive memory execution sequences. The memory read/write order of sequenced dependent operations, such as this invention, and other program inventions related to this art, often have specific ordering requirements. This is known by those familiar to the art as temporal requirements.

To conform to the temporal requirements of this invention, it may be required to use architectural features of various processors, special instructions, which can be interspersed into the program to attain the desired temporal effect. These special instructions include, but are not limited to, cache flush, cache invalidate, memory fence, random short pause, read multiple words, write multiple words among other potentially useful temporal attaining instructions.

The CONSISTENT function as depicted in FIG. 4.

The CONSISTENT function is the most complex of the functions required, and specified, by this invention. The CONSISTENT function will produce a consistent copy of a potentially volatile transitional three word protected pointer being observed and if the protected pointer being observed is in an inconsistent state then the function advances the state of the inconsistent three word protected pointer being observed into consistency in the process of making a copy, now consistent, of the three word protected pointer being observed.

Entry to the CONSISTENT function is made at 400 FIG. 4, where the members Hash, Next and Count of the transitional three word protected pointer t are copied in sequence into the members Hash, Next and Count of the a desired to be consistent snapshot three word protected pointer cs, as depicted in 400 FIG. 4. Progress to 401 FIG. 4.

At 401 FIG. 4, a test is made of the copied hash code, cs.Hash, to see if it is equal to the current state of the transitional hash code, t.Hash. The purpose being to determine if the observation of t were in the state of flux during the copy operation in 400 FIG. 4. Should the verification test at 401 FIG. 4 indicated different hash values then return back to step 400 FIG. 4 to restart the CONSISTENT function. Should the test at 401 FIG. 4 indicate the hash codes are equal, progress to 402 FIG. 4.

At 402 FIG. 4, a test is made of the DCAS supported flag, as copy of which is now in the three word protected pointer cs. If DCAS supported flag is TRUE, then progress to 403 FIG. 4. If DCAS supported flag is FALSE, then progress to 404 FIG. 4.

At 403 FIG. 4, return with consistent snapshot three word protected pointer cs.

At 404 FIG. 4, verify the consistency of the intended to be consistent snapshot three word protected pointer, cs obtained in 400 FIG. 4, by comparing the copied hash, cs.Hash, against a reconstructed hash, HASH, using the copied pointer, cs.Next, and copied count, cs.Count. Should the copied hash match the regenerated hash, then progress to 403 FIG. 4 to return with consistent snapshot three word protected pointer cs. Should the copied hash differ from the regenerated hash, at 404 FIG. 4, then progress in sequence to 405, 406 and 407 FIG. 4.

At 405 FIG. 4, test the copied pointer, cs.Next, with transitional pointer, t.Next. If the pointers differ then return to beginning of CONSISTENT function, at 400 FIG. 4. If pointers are equal, then proceed to 406 FIG. 4.

At 406 FIG. 4, compare the copied count, cs.Count, with the transitional count, t.Count. Should counts differ, then return to the beginning of CONSISTENT function, at 400 FIG. 4. Should counts be the same, then progress to 407 FIG. 4.

At 407 FIG. 4, compare the hash code of the copied hash, cs.Hash, with the transitional hash code, t.Hash. Should the hash codes differ, return to the beginning of CONSISTENT function, at 400 FIG. 4. Should the hash codes be the same, proceed to 408 FIG. 4.

At 408 FIG. 4, produce the next in sequence ABA avoidance sequence number, NextCount, using the NEXTCOUNT function and the intended consistent snapshot three word protected pointer, cs, and then produce a new hash code by way of the hashing function, HASH, with the copied pointer, cs.Next, and the newly produced next in sequence count, NextCount, and save the result in the expected hash code, ExpectedHash, then progress to 409 FIG. 4.

At 409 FIG. 4, a test is made to see if the expected hash code, ExpectedHash, matches the copied hash code, cs.Hash. If the expected hash code, ExpectedHash, matches the copied hash, cs.Hash, then it is deemed that the inconsistency is due only to the copied count, cs.Count, being one sequence number behind the value required of a consistent three word protected pointer, and subsequently, the CONSISTENT function proceeds to attempt the correction of the inconsistent count t.Count, at 417 FIG. 4. Should the expected hash, ExpectedHash, differ from the copied hash, cs.Hash, at 409 FIG. 4, then progression is to 410 FIG. 4.

At 410 FIG. 4, a test is made between the group of bits that are required to be either always zeros or always ones, GROUP0S1S, bit fields of the expected hash, ExpectedHash (should the count have been behind by one), and the GROUP0S1S bits of the copied hash, cs.Hash, if these two bit fields match then it is deemed that the inconsistency is due to the hash alone being modified by simulated DCAS by another thread and that the pointer field of the three word protected pointer, cs.Next, and the counter, cs.Count, are recoverable, and the CONSISTENT function proceeds to 412 FIG. 4. When the GROUP0S1S bit fields of the ExpectedHash differ from that of the GROUP0S1S bit fields of the copied hash, cs.Hash, at 410 FIG. 4, then progress to 411 FIG. 4.

At 411 FIG. 4, a test is made between the GROUP0S1S bits of the REARRANGED copied count, cs.Count, and the GROUP0S1S bits of the copied hash, cs.Hash, if the two bit fields are equal then this indicates that the copied hash, cs.Hash, and the copied count, cs.Count, are in phase (hash produced with same count), and therefore by inference, the copied pointer, cs.Next, is incorrect, but correctible, therefore the function progresses to 413 FIG. 4 to correct the pointer. If at 411 FIG. 4, the two bit fields differ then it is deemed that the pointer, cs.Next, is suspicious, possibly due to the state being advanced by a different thread, and thus the pointer is not immediately correctable, this results in progression to 419 FIG. 4 where an attempt is made to correct the count on the way back to beginning of the CONSISTENT function at 400 FIG. 4.

At 413 FIG. 4, the recovered pointer, RecoveredNext, is produced from the XOR of the REARRANGED copied count, cs.Count, and the copied hash, cs.Hash, and progression is to 415 FIG. 4.

At 415 FIG. 4, a single word compare and swap, CAS, is attempted on the transitional pointer, t.Next, using the copied pointer, cs,Next, as the comperand, and the recovered pointer, RecoveredNext, as the swap value. Should the CAS fail, then we return to the beginning of the CONSISTENT function at 400 FIG. 4. Should the CAS succeed, then we proceed to 420 FIG. 4.

At 420 FIG. 4, the recovered pointer, RecoveredNext, is placed into the copied pointer, cs.Next, thus replacing the inconsistent cs.Next, and now the now consistent copy of a three word protected pointer, cs, of the transient and potentially volatile three word protected pointer, t, is returned to the caller.

Note, in the alternative implementation of this invention, the result of the CAS in 415 FIG. 4 could be ignored, provided the next step in sequence is to proceed back to the beginning of the CONSISTENT function at 400 FIG. 4.

In 419 FIG. 4, a CAS is performed with the count of the transitional three word protected pointer pointer, t.Count, with the copied count, cs.Count, as comperand and the next in sequence ABA avoidance sequence number, NextCount. Regardless of success or failure of CAS, the code progresses back to the beginning of the CONSISTENT function at 400 FIG. 4.

Entry to 412 FIG. 4, is made after the determination is made at 410 FIG. 4, that the pointer, cs.Next, and the count, cs.Count are both inconsistent with the hash, but recoverable from the hash. The recovered pointer, RecoveredNext, is constructed from the XOR of the rearranged bits, REARRANGE, of the NextCount, and the copied hash, cs.Hash. Progress to 414 FIG. 4.

At 414 FIG. 4, the pointer in the transitional three word protected pointer being observed, t.Next, is attempted to be repaired using the copied pointer, cs.Next, as the comperand, and the recovered pointer, RecoveredNext, as the swap value. Should the CAS fail to correct the pointer, t.Next, return to the beginning of the CONSISTENT function, at 400 FIG. 4. Should the CAS repair the transitional pointer, t.Next, progress to 416 FIG. 4.

At 416 FIG. 4, copy the recovered pointer, RecoveredNext, to the consistent copy pointer, cs.Next, and progress to 417 FIG. 4.

At 417 FIG. 4, attempt a repair of the count word of the transitional protected pointer, t.Count, using the copy of the count, cs.Count as a comperand, and the next count, NextCount, as the swap value. Should the repair of count word fail, then the CONSISTENT function is restarted by progressing back to 400 FIG. 4. Should the repair of the count word succeed, then progress to 418 FIG. 4.

At 418 FIG. 4, copy the recovered count, NextCount, to the consistent copy count, cs.Count, and the CONSISTENT function returns with the now consistent copy of the three word protected pointer in cs.

Note, the value returned, cs, is a consistent copy of a potentially volatile three word protected pointer, t, which is subject to change at any moment. The consistent copy, cs, will be consistent, but there is no guarantee that the value is current with t upon return from the function CONSISTENT.

This specification states that there are be temporal issues with regard to the proper implementation of this invention. These temporal issues may require the interspersing of temporal enforcing instructions for a given processor architecture, however, for the sake of clarity of the specification of this invention, the temporal ordering instructions will be omitted from the specification and assumed to be inserted where appropriate by the programmer responsible in attaining the temporal order requirements of this invention. For example, the test at 401 FIG. 4, is one of the situations that is likely to required a temporal enforcing instruction such as cache invalidate of the cache line holding data containing the t.Hash word such that the t.Hash is read from memory instead of cache, and/or the use of a memory fence instruction such that t.Hash isn't (re)read ahead of the copy of the t.Next and t.Count in 400 FIG. 4.

It is well understood by those familiar with the art that temporary buffers, when appropriate, can be maintained in processor registers, while being described as residing in memory. The convenience of placement of the data structures does not alter the fundamental design of this invention.

In order to present a clear and concise detailed understanding of the invention to those skilled in the art, the sequencing of the method will be presented as figures and accompanied with supporting text in this specification. Some of the supporting functions are not depicted in figures, but are commonly known and used by those familiar with the art.

Define AND(x,y) as a function that accepts two words as input arguments and returns a one word value which is the bit for bit logical AND of the corresponding bits of each of the input arguments.

Define OR(x,y) as a function that accepts two words as input arguments and returns a one word value which is the bit for bit logical OR of the corresponding bits of each of the input arguments.

Define XOR(x,y) as a function that accepts two words as input arguments and returns a one word value which is the bit for bit logical exclusive OR (XOR) of the corresponding bits of each of the input arguments.

Define NOT(x) as a function that accepts one word as input and return one word value which is the bit wise complement of the input argument.

Define ROL(x, n) as a function that accepts two words as input, x and n, and returns one word value which is the bit wise rotate to the left of the input argument x, n bit positions. Where the left most bit prior to each bit rotation is placed into the right most bit upon each bit rotation.

Define ROR(x, n) as a function that accepts two words as input, x and n, and returns one word value which is the bit wise rotate to the right of the input argument x, n bit positions. Where the right most bit prior to each bit rotation is placed into the left most bit upon each bit rotation.

Define CARRY( ) as a function which has no arguments but which returns the carry bit of the last integer operation. As a convention, the arithmetic operations perform a clearing of the carry bit immediately prior to the operations. And produce a carry when appropriate.

Define BSWAP(x) as a function that one word as input and returns a one word value which is the byte-wise reversal of the input argument, and is depicted by FIG. 9.

Define three word protected pointer as depicted by FIG. 11, alternately depicted by FIG. 12 and FIG. 13. FIG. 12 illustrates one or more bits of the ABA avoidance sequence number (Count) being used for a flag, flags, or reserved as 0's. FIG. 13 illustrates the three word protected pointer together with an additional word which is not part of the pointer but instead is used in sequencing the Count field per a heuristic method as depicted by FIG. 8b.

Architectural considerations may require alignment of three word protected pointers to align with cache lines for a given architecture. Further, it may be advantageous for a given architecture to re-arrange the order of the variables of the three word protected pointer and/or separate the variables with padding by way of dummy variables.

Additional variables may be added to the three word protected pointer should a heuristic method be used for producing the hash codes, FIG. 8b, or additional variables for diagnostic or statistics purposes.

For portability reasons, in situations where the application using this invention, will run on systems supporting the DCAS instructions a flag bit can be incorporated into the Count field of the three word protected pointer as depicted by 1200 in FIG. 12 (Empty box to left of box with Count).

Upon instantiation of a protected pointer (initialization) all member fields are set to 0 or some other convenient beginning state as the implementation may require.

For abstraction purposes, the type definition for the node pointed to by Next, FIG. 10, FIG. 11, FIG. 12, FIG. 13, is not specified. The specification of the type definition is an implementation issue. When the three word protected pointer is used for lists of nodes, Next will generally contain the address of the link pointer inside a node in the list, which in turn, generally points to the next node in the list and each node in the list pointing to the next node, the last node of the list contains an indicator such as end of list marker. Optionally, nodes in the list the may incorporate a busy flag such as the locked pointer as in the Cartwright double word protected pointer simulated DCAS. Furthermore the pointer to which Next points, is implementation dependent. In some cases it may be a single word unprotected pointer (simple pointer), a two word protected pointer (locking simulated DCAS), or a three word protected pointer (wait free simulated DCAS of this invention).

The declaration of a three word protected pointer which is used to point to the head of a singly linked list can be written as follows

T_TCAS Head

Where the type T_TCAS depicts a structure such as illustrated by FIG. 11, FIG. 12 or FIG. 13. The variable Head, being of type T_TCAS, and containing three member variables (plus optional flags, dummy pad variables and/or heuristic variables for hash function) named: Next, Count and Hash. The member variables, as described in this specification, being accessible by the convention of using a period “.” separating the name of the variable of type of the structure and the name of the member variable within the structure. Examples are Head.Next, Head.Count, and Head.Hash. And the functions using pass by reference when applicable.

For ABA protection sequence numbers where the function produces the sequence n, n+1, n+2, etc. . . . member function NEXTCOUNT and as depicted as in FIG. 8c. The preferred technique for advancement in this invention is to use a 56 bit Count field in a 64 bit word which increments without overflowing into the additional 8 bits in the word and as depicted in FIG. 8.

Consider an ABA protection sequence number that contains a flag in the most significant bit position of the ABA protection sequence number which must be preserved the next in sequence computation as depicted by 1200 in FIG. 12. Flags are often use in higher level functions or for features introduced into the primitive functions such as the simulated DCAS. At times it is advantageous to place the flag into variables use for other purposes. At other times it may be advantageous to use a separate variable for this purpose. The placement of the flags is a design issue for the implementer.

The NEXTCOUNT function when using heuristics would be more complex than other methods is depicted in FIG. 8b. The heuristic method would use a semi-sequential counting method whereby the bit positions in the counter that juxtapose with the bits it the pointer that are not in flux are incremented first then followed by the propagation of the carry to the bit positions in the counter that juxtapose with the bits it the pointer that are in flux.

As pertaining to FIG. 8b, 800 extracts, CountInFlux, the bits in the counter that juxtapose against the heuristically determined bits in flux in the pointer. 801 extracts, CountNotInFlux, the bits in the counter that juxtapose against the heuristically determined bits not in flux in the pointer. 802 is an incrementing method whereby the bits of the counter representing the bits not in flux in the pointer, CountNotInFlux, are incremented with the technique of incorporating a carry propagation mask, BitsInFlux, to produce part of the incrementing counter, NotInFluxPart. 803 is an incrementing method whereby the bits of the counter representing the bits in flux in the pointer, CountInFlux, are incremented with the technique of incorporating a carry propagation mask, NOT(BitsInFlux), together with the carry, CARRY( ), of the increment of the NotInFluxPart, to produce the other part of the incrementing counter, InFluxPart. 804 returns the inclusive or of the NotInFluxPart and the InFluxPart. The resulting count to be used in the NEWTCAS function FIG. 6 together with the simplified hash function FIG. 3a.

The HASH function, as depicted by FIG. 3, and alternately depicted as FIG. 3a, produces a hash code based on the Next and Count words of a three word protected pointer.

The SNAPSHOT is depicted in FIG. 2, is used to obtain a consistent copy of a volatile three word protected pointer.

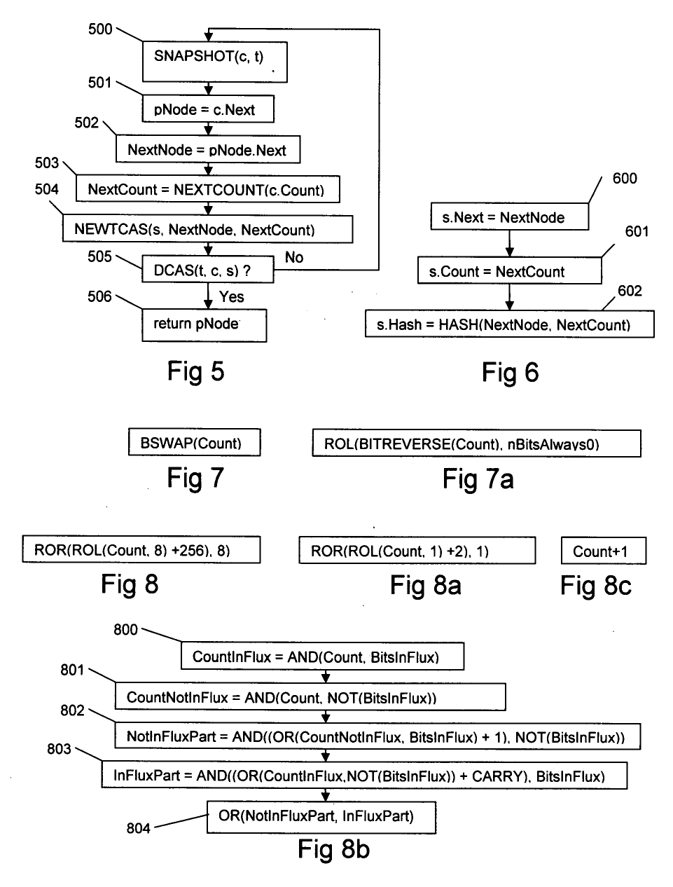

Typical use of these functions is illustrated by FIG. 5.

In referring to FIG. 5, 500 use SNAPSHOT to obtain a consistent copy, c, of the current value of a volatile three word protected pointer, t. The copy, c in 500 of FIG. 5, to be used later, 505 FIG. 5, as: a) the comperand in the next simulated DCAS, and b) for generating the ABA avoidance next in sequence number, NEXTCOUNT, 503 in FIG. 5, for use in the swap value to be used in the next simulated DCAS, s, in 505 FIG. 5. Next, in 501 FIG. 5, obtain a new node pointer, pNode, that is contained in the copy of the protected pointer, c.Next, and then advancing to 502 FIG. 5, using the said new node pointer, pNode, obtain the next node in the list, NextNode, as depicted in 502 of FIG. 5. Then using the consistent copy of the volatile three word protected pointer, c in 500 of FIG. 5, and the NEXTCOUNT function to produce the next in sequence ABA avoidance sequence number, NextCount, as depicted by 503 in FIG. 5. The NextNode and NextCount together with the reference of a three word protected pointer, s, in 504 FIG. 5, issue the NEWTCAS function, FIG. 6, to produce the swap value of the simulated DCAS function as depicted as s in 504 FIG. 5. Next, perform the simulated DCAS, 505 FIG. 5, using the reference of the volatile three word protected pointer, t in 505 FIG. 5, together with the reference of the comperand three word protected pointer, c in 505 FIG. 5, and the reference of the swap value three word protected pointer, s in 505 FIG. 5. The simulated DCAS returns success/fail depending on the success or fail of the simulated DCAS operation. Upon success of simulated DCAS at 505 FIG. 5, return the address of the extracted node, pNode, 506 of FIG. 5, or failing the simulated DCAS at 505 FIG. 5, return to the entry of the extraction function at 500 FIG. 5. The illustration in FIG. 5, for clarity purposes, does not include the tests for empty list nor potential additional code use on extraction of last node in list.

The simulated DCAS, in the preferred embodiment of this invention, includes a provision for running the code on processors without hardware DCAS support as well as on processors that have hardware DCAS support. This invention provides for binary portability of the code incorporating this invention.

FIG. 1 illustrates the simulated DCAS operation. 100, 101, 106, 107, 108 and 110 of FIG. 1, are present on implementations that include the portability feature that makes use of a flag bit in the Count field, 1200 FIG. 12, which is used to indicate the presence (or absence) for hardware support for DCAS. The implementer of this invention may elect to remove this portability feature by eliminating steps 100, 101, 106, 107, 108 and 110 of FIG. 1, and entering the functional description at 102 of FIG. 1.

Entry into the DCAS simulation is at 100 FIG. 1 when using the DCAS supported flag, or entry into the DCAS simulation is at 102 in FIG. 1 if the implementer elects to remove the portability feature. The description of FIG. 1 is performed with the portability feature included.

At 100 FIG. 1, test the three word protected pointer, FIG. 12, swap value for the DCAS supported flag, 1200 FIG. 12, held in the most significant bit of the Count word, and which is depicted as s.DCAS supported flag in 100 FIG. 1. If the flag indicates hardware support for DCAS then progress to 106 FIG. 1 to perform, and return the results, of the hardware supported DCAS operation. If the s.DCAS supported flag did not indicate hardware support for DCAS then progress to 101 FIG. 1.

At 101 FIG. 1, check the Count field of the comperand, c.Count, to see if it is zero. A zero in the Count of the comperand is a special condition which indicates a first use condition. If the comperand count is 0 then progress to 107 of FIG. 1 to query the processor for support of DCAS.

At 107 FIG. 1, the method for query of DCAS support is processor dependent. If hardware support for DCAS is available then progress to 110 FIG. 1 to set the DCAS supported flag in the swap value, s.DCAS supported, and set the Count to 1, s.Count=1. Proceed to the hardware DCAS, 106 FIG. 1. Should the hardware DCAS succeed, as expected, then upon subsequent calls of simulated DCAS to the same three word protected pointer, the simulation routine will observe the s.DCAS supported flag, 100 FIG. 1, as being set and progress directly to the hardware supported instruction(s) 106 FIG. 1. Should the query of processor for DCAS support, 107 FIG. 1, indicate no hardware support for DCAS then proceed to 108 FIG. 1, clear the swap value DCAS supported flag, s.DCAS supported flag=FALSE of 108 FIG. 1, set the Count to 1, s.Count=1 of 108 FIG. 1. Note, the s.DCAS supported flag was FALSE to enter this section so the explicit setting to FALSE could be omitted. Then proceed to 102 FIG. 1.

At 102 FIG. 1, attempt a CAS on the hash word of the three word protected pointer, t.Hash, using the hash word of the snapshot of the three word protected pointer as the comperand, c.Hash, and the hash word of the copy of the next in sequence protected three word pointer as the swap value, s.Hash. If the CAS of the hash fails, at 102 FIG. 1, then the simulated DCAS fails and proceeds to 109 FIG. 1 to return with failure indication. If the CAS of hash succeeds, at 102 FIG. 1, then the simulated DCAS is deemed successful but not yet complete. At this point, the three word protected pointer t is inconsistent but correctable. Proceed to 103 FIG. 1.

At 103 FIG. 1, a CAS is performed on the pointer word of the three word protected pointer, t.Next, using the pointer word of the snapshot of the three word protected pointer as the comperand, c.Next, and the pointer word of the next in sequence three word protected pointer as the swap value, s.Next. Proceed to 104 FIG. 1. Note, the CAS at 103 FIG. 1 is not tested for success or failure. The thread issuing this instruction sequence is in competition with the other threads on the system to complete this sequence of the simulated DCAS. The other threads are capable of repairing this three word protected pointer. We perform the CAS at 103 FIG. 1 because there is less processing time overhead to perform the CAS here as opposed to performing the CAS in the code that repairs the three word protected pointer.

At 104 FIG. 1, a CAS is performed on the count word of the three word protected pointer, t.Count, using the count word of the snapshot of the three word protected pointer as the comperand, c.Count, and the count word of the next in sequence three word protected pointer as the swap value, s.Count. Proceed to 105 FIG. 1. Note, the CAS at 104 FIG. 1 is not tested for success or failure. The thread issuing this instruction sequence is in competition with the other threads on the system to complete this sequence of the simulated DCAS. The other threads are capable of repairing this three word protected pointer. We perform the CAS at 104 FIG. 1 because there is less processing time overhead to perform the CAS here as opposed to performing the CAS in the code that repairs the three word protected pointer.

At 105 FIG. 1, return an indication of Success for simulated DCAS.

Cautionary note, an implementer of this invention might assume that should the CAS in 103 FIG. 1 fail, indicating a different thread advanced the Next word during a repair, that the thread that made the repair on the Next word also made the repair on the Count word. It is incorrect to make this assumption since the thread making the repair on Next could be suspended prior to making the repair on Count. Tests could be inserted to check to see if the CAS should be attempted, however these tests may introduce more overhead than performing a failing CAS operation. It is up to the implementer to make this determination.

The prerequisites for performing the simulated DCAS are: a) to obtain a consistent snapshot of the protected pointer and, b) to produce the swap value for the simulated DCAS.

The comperand is obtained by calling the SNAPSHOT function, as depicted in FIG. 2. The SNAPSHOT function, when necessary, will force the volatile three word protected pointer, t in 200 FIG. 2, into consistency, and subsequently ensuring that the returned value from SNAPSHOT, ss in 200 FIG. 2, was at least momentarily consistent. Best operation of DCAS, either by simulation or hardware, is to program to keep as short as possible, the time interval between the time of the snapshot and the time of the DCAS. The shorter the time, the higher the probability of success of the DCAS.

The swap value is generally produced from a pointer extracted from the list (obtained by following the pointer in the snapshot) together with the next in sequence count generated from the snapshot.

Functional description of SNAPSHOT FIG. 2.

At 200 FIG. 2, in an atomic manner, or lacking that capability, in a consistent manner, copy the Next and Count words of the potentially volatile three word protected pointer, t, to the Next and Count words of a three word protected pointer, ss. Progress to 201 FIG. 2.

At 201 FIG. 2, check the DCAS supported flag held in the Count word of ss. If the flag indicates hardware support for DCAS then progress to 208 FIG. 2 to return from the SNAPSHOT function. If the test of the flag for hardware support of DCAS, 201 FIG. 2, indicates FALSE, then progress to 202 FIG. 2.

At 202 FIG. 2, test the Count word, ss.Count, if zero, then this is an indication that initialization is to be performed and progress to 209 FIG. 2.

At 209 FIG. 2, query of the processor for hardware support of DCAS. If hardware support for DCAS is available then proceed to 207 FIG. 2.

At 207 FIG. 2, set the DCAS supported flag to TRUE in both the protected pointer being observed t, t.DCAS supported, and the copy there from, ss, ss.DCAS supported flag, and set the Count word to 1 in both the protected pointer being observed t, t.Count, and the copy there from, ss, ss.Count, then progress to 208 FIG. 2 to return from the SNAPSHOT function.

Should the query of hardware support for DCAS, 209 FIG. 2, indicate no hardware support for DCAS then progress to 210 FIG. 2.

At 210 FIG. 2, set the DCAS supported flag to FALSE in the copy of the protected pointer being observed, ss.DCAS supported flag, and set the Count word to 1 in the copy of the protected pointer being observed, ss.Count. Then proceed to 203 FIG. 2.

At 203 FIG. 2, the consistency of the copy of the protected pointer being observed, ss, is verified for consistency by generating a hash code, HASH, using the copy of the pointer of the three word protected pointer being observed, ss.Next, and the copy of the count word of the three word protected pointer being observed, ss.Count. The newly generated hash code is inserted into hash word of the copy of the three word protected pointer being observed, ss.Hash, under the anticipation that the three word protected pointer being observed, t in 200 FIG. 2, is consistent. Progress to 204 FIG. 2.

At 204 FIG. 2, the consistency of the snapshot, ss, is verified by comparing the anticipated hash code of the copy of the protected pointer being observed, ss.Hash, against the current hash code of the of the protected pointer being observed, t.Hash. Should the anticipated hash code match the current hash code then the snapshot is deemed consistent and the SNAPSHOT function progresses to 206 FIG. 2 to return. Should the anticipated hash code differ from the current hash code then the snapshot is deemed inconsistent, and thereby the three word protected pointer being observed, t, in 200 FIG. 2, is deemed as being potentially inconsistent, in a state of flux, or has advanced to a new consistent state in advance of the state observed in 200 FIG. 2. Under this circumstance progress to 205 FIG. 2.

At 205 FIG. 2, a call to the CONSISTENT function is performed to advance the three word protected pointer under observation, t, into consistency and then save the consistent copy in ss. Then progress to 206 FIG. 2 to return from the SNAPSHOT function.

It is well understood those skilled in the art, that an implementation of the functional description of SNAPSHOT may include optimizations whereby internal registers are used to perform the (or some of the) functional steps and/or perform the functional steps in an overlapped manner and/or in a slightly different order. Any and all such rearrangements, wither necessary or superfluous, do not introduce new functionality to the abstraction of the snapshot function.

What I claim as my invention is:

1. A method in a programming system capable of running a plurality of threads to perform a lock free and wait free emulation of an atomic double word compare and swap operation through the use three atomic single word compare and swap operations.

2. The method of claim 1 where the double word, formerly used in the double word compare and swap, consisting of a pointer and a counter, is accompanied by a third word containing a hash code derived form the pointer and counter of the former double word, now triple word, hereby declared as a three word protected pointer.

3. The method where the pointer word of claim 2 can be determined or specified as pointing to a valid memory location.

4. The method of claim 2 where identifiable bit positions within a valid pointer can be predetermined as being always 0 or always 1.

5. The method of claim 2 where identifiable bit positions within a valid pointer can be grouped into a zone of zero or more bits that are required to be all zeros or all ones.

6. The method of claim 2 together with heuristically observed pointer values whereby identifiable bit positions within the pointer are observed to vary with use.

7. The method of claim 6 whereby identifiable bit positions within the pointer are observed to remain static with use.

8. The method of claim 2 together with the methods of claim 4, claim 5, claim 6 and claim 7, where said hash code method generated from the pointer and counter of claim 2, and stored together with the pointer and counter of claim 2 into the triple word of claim 2, is a sufficiently strong of a hash code, whereby after storage is capable to be used to detect, subsequent to said storage, alterations to a) the hash code, b) the pointer, c) the counter, d) the hash code and the pointer, e) the hash code and the counter, f) the pointer and the counter, and finally g) the hash code, the pointer and the counter, while executing code sequences within the normal operational parameters of this invention.

9. The method of claim 8 whereby inference of the lack of detection of change implies un-altered three word protected pointer.

10. The method of claim 8 whereby immediately after generation and storage of hash code in claim 8, but prior to alteration of the stored hash code, pointer and/or counter in clam 8, that: a) the same hash code can be re-derived from the hash method when supplied with the pointer and counter, b) the same pointer can be re-derived from a method using the hash code and counter, and c) the same counter can be re-derived from a method using the hash code and the pointer.

11. The method of claim 8, where upon identification of the type of alteration of a member or members of the three word protected pointer that the appropriate repair operation be selected.

12. The method of claim 8, where the hash code is capable of being identified as being generated from next in sequence of the current counter and where when the current pointer is inconsistent with pointer used to generate hash code observed with next in sequence counter, and whereby the current hash code and next in sequence counter can be used with the re-derivable properties as described in claim 10 to derive the pointer used to generate current hash code.

13. The method of claim 8, where the hash code is capable of being identified as being generated from same in sequence of the current counter and where when the current pointer is inconsistent with pointer used to generate hash code observed with current in sequence counter, and whereby the current hash code and current in sequence counter can be used with the re-derivable properties as described in claim 10 to derive the pointer used to generate current hash code.

14. The method of claim 8, where the hash code is capable of being identified as being generated from next in sequence of the current counter and where when the current pointer is consistent with pointer used to generate hash code observed with next in sequence counter, and whereby next in sequence counter can be used with the re-derivable properties as described in claim 10 to derive the counter used to generate current hash code.

15. The method of claim 8, where the hash code is capable of being identified as being generated from a counter that is neither the current counter nor the next in sequence of the current.

16. The method whereby use of method of claim 9, or with the use of claim 11 and claim 12, or claim 13, or claim 14, is used to obtain a copy of a three word protected pointer, while, if necessary, advancing the state of an inconsistent three word protected pointer into consistency by affecting the appropriate repairs to the three word protected pointer being copied.

17. The method of claim 16, whereby the consistent copy of a three word protected pointer is used for the comperand, in simulated atomic double word compare operation.

18. The method of claim 17, whereby the copy of a three word protected pointer is used in part to generate a three word protected pointer swap value for use in simulated atomic double word compare operation.

19. The method whereby the single word compare and swap instruction used on the hash word of a three word protected pointer, together with the hash word of a comperand three word protected pointer, and hash word of a swap value a three word protected pointer, is used to make the determination of success or failure of the issuance of the first in the sequence of three single word compare and swap instructions, used in the performance of a simulated double word compare and swap instruction, whereby indication of failure on the compare and swap of the hash word, indicates failure of simulated double word compare and swap, and thus termination of simulated double word compare and swap, with return of indication of failure, or upon success of single word compare and swap of the respective hash words, proceed with the compare and swap of the respective pointer words, without regard to success or failure of the compare and swap of the respective pointer words, then proceed with compare and swap of respective counter words, without regard to success or failure of the compare and swap of respective counter words, then return success from simulated double word compare and swap instruction.
